(19) United States
(12) Patent Application Publication
(10) Pub. No.: US 2012/0218288 A1
(43) Pub. Date: Aug. 30, 2012

(54) INTERACTIVE PROGRAM SYSTEM

(76) Inventor: Bruce C.H. CHENG, Taoyuan Hsien (TW)

(21) Appl. No.: 13/034,232

(22) Filed: Feb. 24, 2011

(51) Int. Cl. G09G 5/00

(52) U.S. Cl. 345/619

(57) ABSTRACT

An interactive program system for a first viewer and a second viewer to share a display is provided. The display can show two different video images or frames at the same time, and with a screen sharing mechanism, only the video program selected by viewers can be seen by the viewers. The screen sharing mechanism is implemented by code-division or frequency-division technology.

### BACKGROUND OF THE INVENTION

1. Field of the Invention

The present invention relates to an interactive program system, and more particularly to an interactive program system with screen sharing mechanism.

2. Description of the Related Art

Traditional displays can only provide one video or TV program from one program source to all viewers at a same time. When one user plays a video game, other viewers cannot watch a TV program. However, with the growth and development of multi-player video games, it is desirable to provide a display system which can provide at least two sets of images to a plurality of viewers.

### BRIEF SUMMARY OF THE INVENTION

One embodiment of the invention provides an interactive program system for a first viewer and a second viewer to share a display. The interactive program system comprises a video console, a processing unit, a display, a first eyeglass and a second eyeglass. The video console comprises a timing generator, and loads and executes a program video, wherein the timing generator is adapted to provide a timing signal which is associated with the program video. The processing unit, electrically connected to the video console, receives and processes the program video to generate a first content and a second content. The display, electrically coupled to the video console and the processing unit, displays the first content and the second content. The first eyeglass for the first viewer comprises a first receiving device and a first processor. The first receiving device receives the first content. The first processor processes the first content to allow the first viewer to see a first frame corresponding to the first content on the display. The second eyeglass for the second viewer comprises a second receiving device and a second processor. The second receiving device receives the second content. The second processor processes the second content to allow the second viewer to see a second frame corresponding to the second content on the display. The first frame is representative of the first viewer's perspective of a scene, and the second frame is representative of the second viewer's perspective of the scene.

Another embodiment of the invention provides a display system comprising a video source, a display panel, a screen sharing device, a first eyeglass and a second eyeglass. The video source provides a first content and a second content. The screen sharing device, electrically connected to the video source and the display panel, processes and shows the first content and the second content on the display panel, wherein the screen sharing device comprises a timing controller for providing a timing signal in accordance with the first content and the second content, and a transmitter for transmitting a first parameter and a second parameter associated with the first content and the second content, respectively. The first eyeglass for a first viewer comprises a first receiver, a first synchronization device and a first processor. The first receiver receives the first parameter. The first synchronization device synchronizes a first frame associated with the first content with the timing signal in accordance with the first parameter. The first processor processes the first content to allow the first viewer to see the first frame on the display panel. The second eyeglass for a second viewer comprises a second receiver, a second synchronization device and a second processor. The second receiver receives the second parameter. The second synchronization device synchronizes a second frame associated with the second content with the timing signal in accordance with the second parameter. The second processor processes the second content to allow the second viewer to see the second frame on the display panel.

Another embodiment of the invention provides an interactive program system. The system comprises a game console, an audio and video processing device, a display, a first eyeglass and a second eyeglass. The game console provides an audio content and a video content. The audio and video processing device, electrically connected to the game console, comprises a multiplexer, an audio controller, a video controller, a timing controller and a radio transmitter. The multiplexer processes the audio content and the video content to generate divided contents in accordance with the audio controller, the video controller, and the timing controller. The display, electrically connected to the audio and video processing device, displays a first set of frames and a second set of frames corresponding to the divided contents. The first eyeglass comprises a first demultiplexer, a first radio receiver, and a first earphone. The first demultiplexer demultiplexes the first set of frames to allow a first user wearing the first eyeglass to see the first set of frames. The first radio receiver communicates with the radio transmitter and the first earphone. The second eyeglass comprises a second demultiplexer, a second radio receiver, and a second earphone, wherein the second demultiplexer demultiplexes the second set of frames to allow a second user wearing the second eyeglass to see the second set of frames, the second radio receiver communicates with the radio transmitter and the second earphone, and the first set of frames and the second set of frames are interactive frames between the first user and the second user.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of an interactive program system according to an embodiment of the invention.

FIG. 2 is a block diagram of the first eyeglass 14 in FIG. 1.

FIG. 3 is a block diagram of the second eyeglass 15 in FIG. 1.

FIG. 4 is a schematic diagram of a display system according to an embodiment of the invention.

FIG. 5 is a schematic diagram of an interactive program system according to another embodiment of the invention.

FIG. 6 is a block diagram of the audio and video processing device 53 in FIG. 5 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

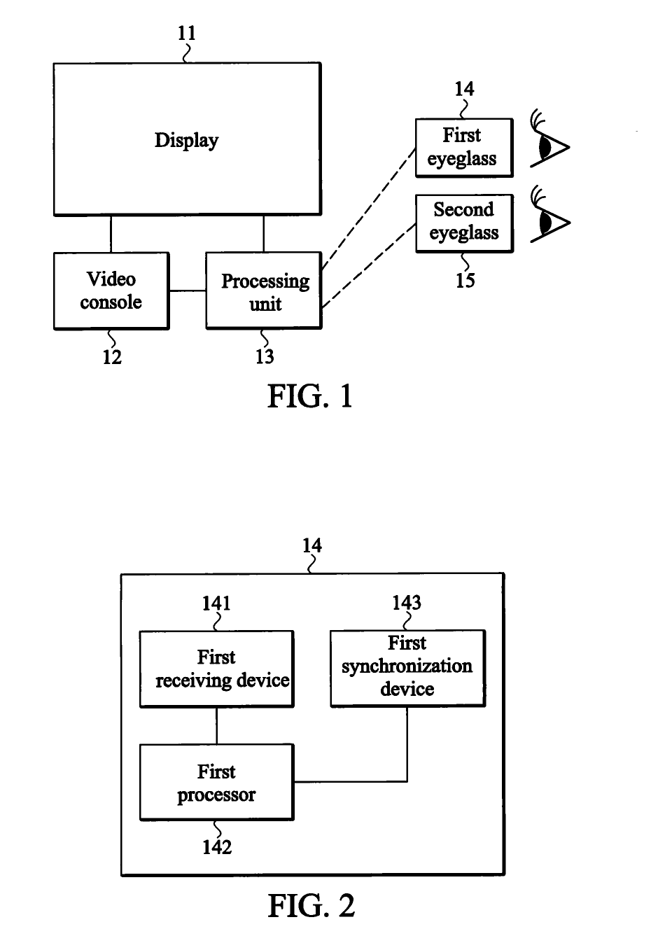

FIG. 1 is a schematic diagram of an interactive program system according to an embodiment of the invention. The interactive program system 10 for a first viewer and a second viewer comprises a video console 12, a processing unit 13, a display 11, a first eyeglass 14 for the first viewer and a second eyeglass 15 for the second viewer. The display 11 is, for example, a normal television, an LCD television, a CRT or LCD display. The video console 12 comprises a timing generator (not shown in FIG. 1), loads and executes a program video, wherein the timing generator is adapted to provide a timing signal which is associated with the program video. The processing unit 13 is electrically connected to the video console 12, receives and processes the program video to generate a first content and a second content, respectively for the first viewer and the second viewer according to the timing signal from the video console 12. The processing unit 13 transmits the first content and the second content to the display 11. The processing unit 13 is configured to generate the first content and the second content by code division or frequency division.

FIG. 2 is a block diagram of the first eyeglass 14 in FIG. 1. The first eyeglass 14 for the first viewer comprises a first receiving device 141, a first synchronization device 143 and a first processor 142. The first synchronization device 143 receives the timing signal associated with the program video to synchronize the first eyeglass 14 with the video console 12 and the processing unit 13. The first receiving device 141 receives the first content from display 11. The first processor 142 processes the first content to allow the first viewer to see a set of first frames corresponding to the first content on the display 11. The processing unit 13 informs the first processor 142 about the type of code division or frequency division to be applied in the processing unit 13, and transmits the corresponding parameters or information to the first processor 142 to generate the first frames.

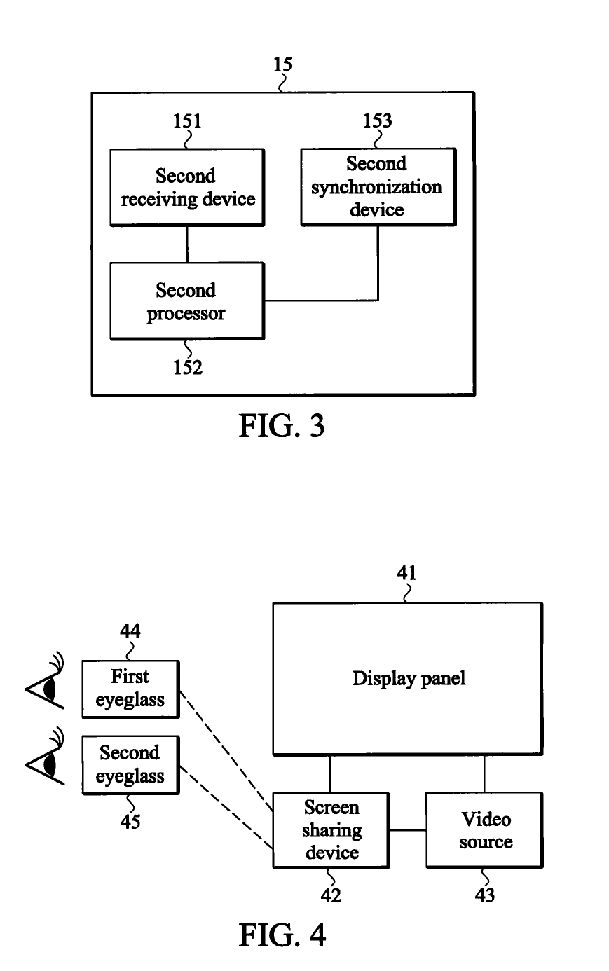

FIG. 3 is a block diagram of the second eyeglass 15 in FIG. 1. The second eyeglass 15 for the second viewer comprises a second receiving device 151, a second synchronization device 153 and a second processor 152. The second synchronization device 153 receives the timing signal associated with the program video to synchronize the second eyeglass 15 with the video console 12 and the processing unit 13. The second receiving device 151 receives the second content. The second processor 152 processes the second content to allow the second viewer to see a set of second frames corresponding to the second content on the display 11. The processing unit 13 informs the second processor 152 about the type of code division or frequency division to be applied in the processing unit 13, and transmits the corresponding parameters or information to the second processor 152 to generate the second frames.

FIG. 4 is a schematic diagram of a display system according to an embodiment of the invention. The display system 40 comprises a video source 43, a display panel 41, a screen sharing device 42, a first eyeglass 44 and a second eyeglass 45. The video source 43 provides a first content and a second content. The video source 43 is configured to provide, for example, digital TV programs, cable TV programs, or video game streams. The video source 43 is further configured to receive one or more feeds from, for example, a DVD player, a Blue-Ray DVD player, a multimedia processor, a TV gamer, a network media processor, a communicating device, or a program on a hard disk drive.

The screen sharing device 42 is electrically connected to the video source 43 and the display panel 41, and processes and shows both the first content and the second content on the display panel 41, wherein the screen sharing device 42 comprises a timing controller (not shown in FIG. 4) for providing a timing signal in accordance with the first content and the second content, and a transmitter (not shown in FIG. 4) for transmitting a first parameter and a second parameter associated with the first content and the second content, respectively. The first eyeglass 44 for a first viewer comprises a first receiver, a first synchronization device and a first processor as like what mentioned in FIG. 2. The first receiver receives the first parameter. The first synchronization device synchronizes a first frame associated with the first content with the timing signal in accordance with the first parameter. The first processor processes the first content to allow the first viewer to see the first frame on the display panel 41. The second eyeglass 45 for a second viewer comprises a second receiver, a second synchronization device and a second processor as like what mentioned in FIG. 3. The second receiver receives the second parameter. The second synchronization device synchronizes a second frame associated with the second content with the timing signal in accordance with the second parameter. The second processor processes the second content to allow the second viewer to see the second frame on the display panel 41.

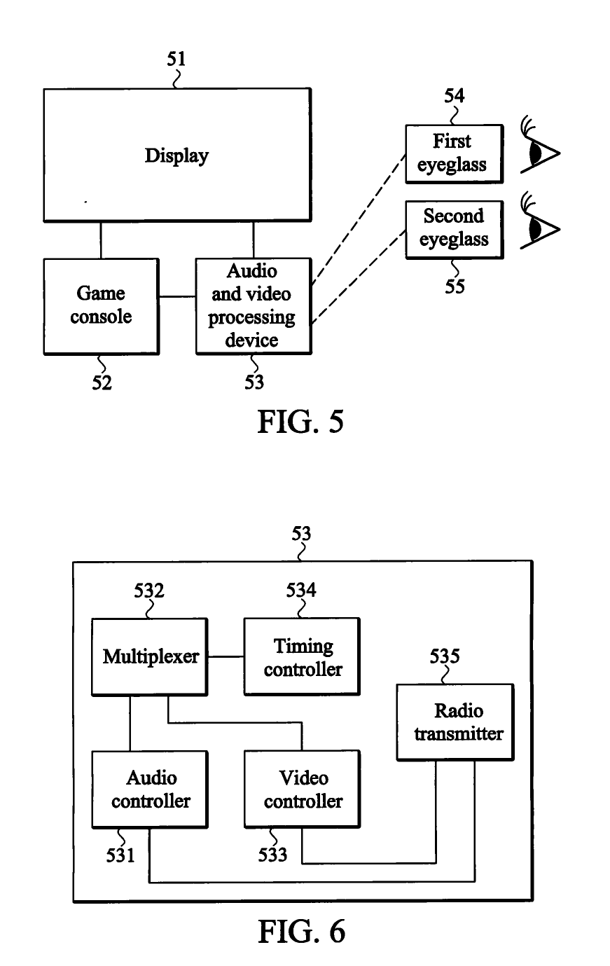

FIG. 5 is a schematic diagram of an interactive program system according to another embodiment of the invention. The interactive program system 50 comprises a game console 52, an audio and video processing device 53, a display 51, a first eyeglass 54 and a second eyeglass 55. The game console 52 provides an audio content and a video content. The audio and video processing device 53 is electrically connected to the game console 52 to generate a plurality of divided contents.

The display 51 is electrically connected to the audio and video processing device 53 to display a first set of frames and a second set of frames corresponding to the divided contents. The first eyeglass 54 comprises a first demultiplexer, a first radio receiver, and a first earphone. The first demultiplexer demultiplexes the first set of frames to allow a first user wearing the first eyeglass 54 to see the first set of frames. The first radio receiver communicates with a radio transmitter of the audio and video processing device 53 (will be described later) and the first earphone. The second eyeglass 55 comprises a second demultiplexer, a second radio receiver, and a second earphone, wherein the second demultiplexer demultiplexes the second set of frames to allow a second user wearing the second eyeglass 55 to see the second set of frames, the second radio receiver communicates with the radio transmitter and the second earphone, and the first set of frames and the second set of frames are interactive frames between the first user and the second user.

FIG. 6 is a block diagram of the audio and video processing device 53 in FIG. 5 according to an embodiment of the invention. The audio and video processing device 53 comprises a multiplexer 532, an audio controller 531, a video controller 533, a timing controller 534 and a radio transmitter 535. The multiplexer 532 processes the audio content and the video content to generate divided contents in accordance with the audio controller 531, the video controller 533, and the timing controller 534. The radio transmitter 535 communicates with the radio receivers and the earphones of the first eyeglass 54 and the second eyeglass 55, respectively and transmits the required parameters or information to the radio receivers and the earphones of the first eyeglass 54 and the second eyeglass 55, respectively. The audio and video processing device 53 is configured to process the audio content and the video content by using a code division mechanism or a frequency division mechanism.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An interactive program system for a first viewer and a second viewer to share a display, comprising:
a video console, having a timing generator, for loading and executing a program video, wherein the timing generator is adapted to provide a timing signal which is associated with the program video;
a processing unit, electrically connected to the video console, for receiving and processing the program video to generate a first content and a second content;
a display, electrically coupled to the video console and the processing unit, for displaying the first content and the second content;
a first eyeglass for the first viewer comprising:
a first receiving device for receiving the first content; and
a first processor for processing the first content to allow the first viewer to see a first frame corresponding to the first content on the display; and
a second eyeglass for the second viewer comprising:
a second receiving device for receiving the second content; and
a second processor for processing the second content to allow the second viewer to see a second frame corresponding to the second content on the display, wherein the first frame is representative of the first viewer's perspective of a scene, and the second frame is representative of the second viewer's perspective of the scene.

2. The interactive program system as claimed in claim 1, wherein the processing unit is configured to generate the first content and the second content by code division.

3. The interactive program system as claimed in claim 1, wherein the processing unit is configured to generate the first content and the second content by frequency division.

4. The interactive program system as claimed in claim 1, wherein the first eyeglass further comprises a first synchronization device for synchronizing the first content with the timing signal.

5. The interactive program system as claimed in claim 1, wherein the second eyeglass further comprises a second synchronization device for synchronizing the second content with the timing signal.

6. A display system, comprising:
a video source for providing a first content and a second content;
a display panel;
a screen sharing device, electrically connected to the video source and the display panel, for processing and showing the first content and the second content on the display panel, wherein the screen sharing device comprises a timing controller for providing a timing signal in accordance with the first content and the second content, and a transmitter for transmitting a first parameter and a second parameter associated with the first content and the second content, respectively;
a first eyeglass for a first viewer, comprising:
a first receiver for receiving the first parameter;
a first synchronization device for synchronizing a first frame associated with the first content with the timing signal in accordance with the first parameter; and
a first processor for processing the first content to allow the first viewer to see the first frame on the display panel; and
a second eyeglass for a second viewer, comprising:
a second receiver for receiving the second parameter;
a second synchronization device for synchronizing a second frame associated with the second content with the timing signal in accordance with the second parameter; and
a second processor for processing the second content to allow the second viewer to see the second frame on the display panel.

7. The display system as claimed in claim 6, wherein the screen sharing device is configured to process the first content and the second content by code division.

8. The display system as claimed in claim 6, wherein the screen sharing device is configured to process the first content and the second content by frequency division.

9. The display system as claimed in claim 6, wherein the video source is configured to provide digital TV programs, cable TV programs, or video game streams.

10. The display system as claimed in claim 9, wherein the video source is further configured to receive one or more feeds from a DVD player, a Blue-Ray DVD player, a multimedia processor, a TV gamer, a network media processor, a communicating device, or a program on a hard disk drive.

11. The display system as claimed in claim 6, wherein the first processor comprises a demultiplexer for demultiplexing the first content.

12. The display system as claimed in claim 6, wherein the second processor comprises a demultiplexer for demultiplexing the second content.

13. The display system as claimed in claim 6, wherein the first processor comprises a demodulator for demodulating the first content.

14. The display system as claimed in claim 6, wherein the second processor comprises a demodulator for demodulating the second content.

15. An interactive program system, comprising:
a game console to provide an audio content and a video content;
an audio and video processing device, electrically connected to the game console, comprising a multiplexer, an audio controller, a video controller, a timing controller and a radio transmitter, wherein the multiplexer processes the audio content and the video content to generate divided contents in accordance with the audio controller, the video controller, and the timing controller;
a display, electrically connected to the audio and video processing device, for displaying a first set of frames and a second set of frames corresponding to the divided contents;
a first eyeglass comprising a first demultiplexer, a first radio receiver, and a first earphone, wherein the first demultiplexer demultiplexes the first set of frames to allow a first user wearing the first eyeglass to see the first set of frames, and the first radio receiver communicates with the radio transmitter and the first earphone; and
a second eyeglass comprising a second demultiplexer, a second radio receiver, and a second earphone, wherein the second demultiplexer demultiplexes the second set of frames to allow a second user wearing the second eyeglass to see the second set of frames, the second radio receiver communicates with the radio transmitter and the second earphone, and the first set of frames and the second set of frames are interactive frames between the first user and the second user.

16. The interactive program system as claimed in claim 15, wherein the audio and video processing device is configured to process the audio content and the video content by using a code division mechanism.

17. The interactive program system as claimed in claim 15, wherein the audio and video processing device is configured to process the audio content and the video content by using a frequency division mechanism.
